(19) United States
(12) Patent Application Publication
(10) Pub. No.: US 2016/0128471 A1
(43) Pub. Date: May 12, 2016

(54) Tool Cabinet

(71) Applicant: Ting Yu Chang, Taichung City (TW)

(72) Inventor: Ting Yu Chang, Taichung City (TW)

(21) Appl. No.: 14/980,332

(22) Filed: Dec. 28, 2015

Related U.S. Application Data
(63) Continuation-in-part of application No. 14/696,584, filed on Apr. 27, 2015.

(30) Foreign Application Priority Data
May 15, 2014 (TW) 103208478

(51) Int. Cl. A47B 88/04; B25H 3/02; B62B 3/00; A47B 81/00; A47B 88/16

(52) U.S. Cl. CPC A47B 88/047; A47B 81/00; A47B 88/16; B62B 3/00; B25H 3/028

(57) ABSTRACT

A tool cabinet includes a cabinet body, a drawer received by the cabinet body, and an opening and closing device engaged with the cabinet body and the drawer. The opening and closing device includes a first and second holder, a displacing member, a flipping member, and a biasing member. The displacing member is restrained by the first and second holders and is adapted to be inserted into a recessed structure defined by the cabinet body. The displacing member is biased by the biasing member. The flipping member is restrained by the first holder and is pivotal relative thereto. The displacing and flipping members include a first and second slant surface in contact with each other. Upon pivoting the flipping member, the displacing member is adapted to be moved. The drawer is prevented from being opened when the displacing member is inserted into the recessed structure.

### CROSS REFERENCE TO RELATED APPLICATION

The present application is a continuation application of U.S. patent application Ser. No. 14/696,584 filed on Apr. 27, 2015, of which the disclosure is incorporated herein.

### BACKGROUND OF THE INVENTION

1. Field of the Invention

The present invention relates to a tool cabinet and, in particular, to a tool cabinet including at least one drawer and at least one drawer opening and closing device interacted with the at least one drawer and configured to be movable to a first position in which the at least one drawer can be pulled out, and to a second position in which the at least one drawer is locked and prevented from being pulled out.

2. Description of the Related Art

With reference to FIGS. 11 and 12 for a conventional drawer opening and closing device, the conventional drawer opening and closing device comprises a blocking member 41 disposed on a side of a cabinet 4, and a pivot member 51 pivotally installed to the front of the drawer 5. The pivot member 51 is installed to the front of the drawer 5 by a pivot 52, and the pivot 52 is installed at a position other than the center of the pivot member 51. The pivot 52 controls the pivoting status of the pivot member 51 through a torsion spring. Therefore, the pivot member 51 is disposed at the right end portion of the pivot 52 and the pivot member 51 is normally drooped due to its own weight and is blocked by the blocking member 41. Thus, the drawer 5 cannot be pulled outwardly (wherein, the direction of pulling out the drawer 5 is the right side of the figure). To pull out the drawer 5, a user needs to flip the pivot member 51 upwardly to swing the pivot member 51 to rise to a position in order to separate the blocking member 41. With the aforementioned structure, a drawer opening and closing mechanism is formed.

However, the core technology of such conventional structure resides on the position of installing the pivot 52 onto the pivot member 51, and the choice of such position faces several difficulties. Firstly, if the selected position is too close to the middle of the pivot member 51, then the pivot member 51 will be difficult to use its own weight to pivot and will normally droop to the blocking member 41. On the contrary, if the selected position is too near an end of the pivot member 51, then the torque formed by the weight of the pivot member 51 will be too large, so that the torsion spring 53 may be overloaded and damaged easily. In summation, the conventional drawer opening and closing device requires improvements.

The present invention is, therefore, intended to obviate or at least alleviate the problems encountered in the prior art.

### SUMMARY OF THE INVENTION

According to the present invention, a tool cabinet includes a cabinet body having a bottom side, a top side, and a lateral side. The bottom and top sides are disposed oppositely in a height direction of the cabinet body. The lateral side extends in the height direction of the cabinet body from the bottom side to the top side. The bottom, top, and the lateral sides cooperate to define a chamber with an opening. At least one pair of slide modules is disposed oppositely on the lateral side. At least one drawer is received by the chamber and slidably engaged with and retained by the at least one pair of slide modules between an open position partially extending outside chamber through the opening and a closed position received in the chamber. At least one opening and closing device is engaged with the cabinet body and the at least one drawer and is configured to selectively prevent the at least one drawer from being opened. The at least one drawer is moved from the closed position to the open position in a first direction upon being opened. The opening and closing device includes a first and second holder, a displacing member, a flipping member, a biasing member, and a control input. The first and second holders are attached to a front panel of a drawer box of the at least one drawer. The first holder is disposed corresponding to a recessed structure defined by the lateral side of the cabinet body. The displacing member is restrained by the first and second holders and is movable relative thereto. The displacing member is adapted to be moved to a position in which a control end defined at an end thereof is disposed outside the first holder and inserted into the recessed structure. The displacing member is biased by the biasing member. The biasing member is restrained by the displacing member and the second holder. The flipping member is restrained by the first holder and is pivotal relative thereto. The displacing member includes a first slant surface and the flipping member includes a second slant surface in contact with the first slant surface. Upon pivoting the flipping member about a pivot axis, the displacing member is adapted to be moved in a second direction which is transverse to the first direction. The pivot axis extends in the second direction. The control input is integrated with the flipping member. Upon pivoting the control input in the second direction, the flipping member is adapted to be pivoted in the second direction. The at least one drawer in the closed position is prevented from being opened when the control end is inserted into the recessed structure.

### BRIEF DESCRIPTION OF THE DRAWINGS

FIG. 1 is a perspective view of a tool cabinet in accordance with the present invention.

FIG. 2 is a perspective view illustrating a drawer of the tool cabinet of FIG. 1 being opened.

FIG. 3 is a partial exploded perspective view of the tool cabinet of FIG. 1.

FIG. 4 is a partial exploded perspective view of the tool cabinet shown in FIG. 1.

FIG. 5 is a partial exploded perspective view of the tool cabinet at an angle different than that of FIG. 4.

FIG. 6 is a partial cross-sectional view showing a drawer opening and closing device of the tool cabinet of FIG. 1 in a first position.

FIG. 7 is another partial cross-sectional view showing the drawer opening and closing device of the tool cabinet of FIG. 1 in the first position.

FIG. 8 is another partial cross-sectional view showing the drawer opening and closing device of the tool cabinet of FIG. 1 in the first position.

FIG. 9 is a partial cross-sectional view showing the drawer opening and closing device of the tool cabinet of FIG. 1 in a second position.

FIG. 10 is another partial cross-sectional view showing the drawer opening and closing device of the tool cabinet of FIG. 1 in the second position.

FIGS. 11 and 12 are schematic planar views of the using statuses of a conventional structure.

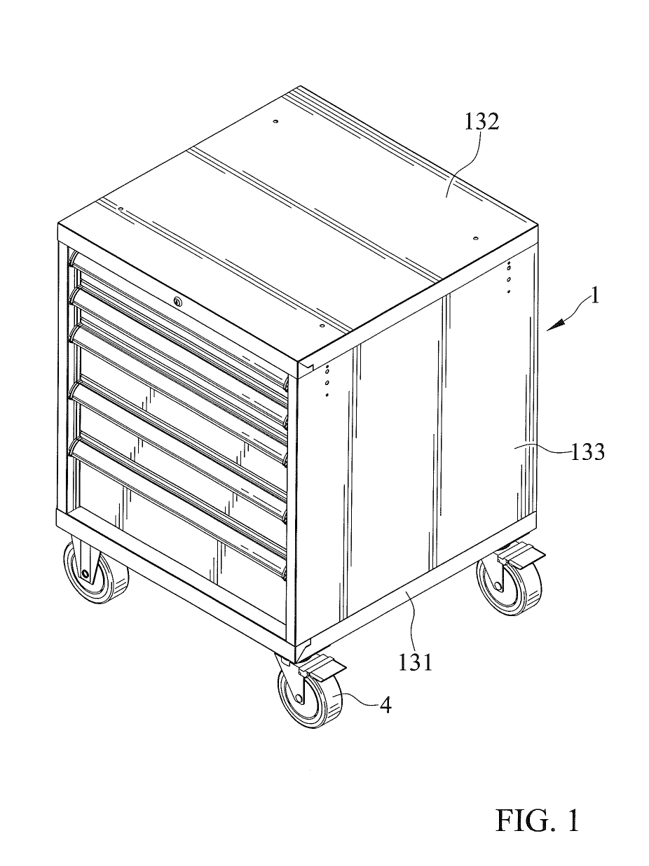

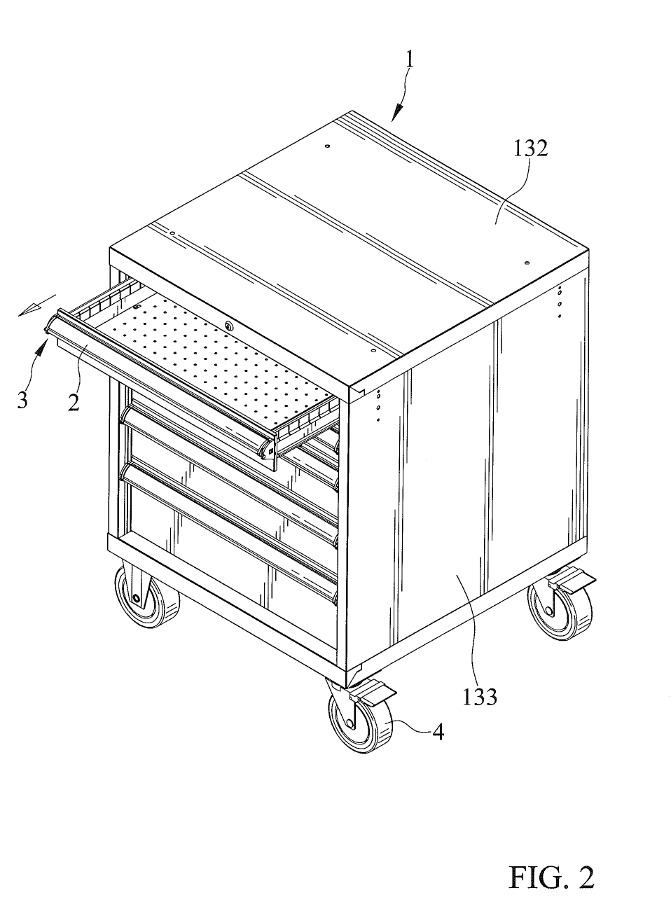

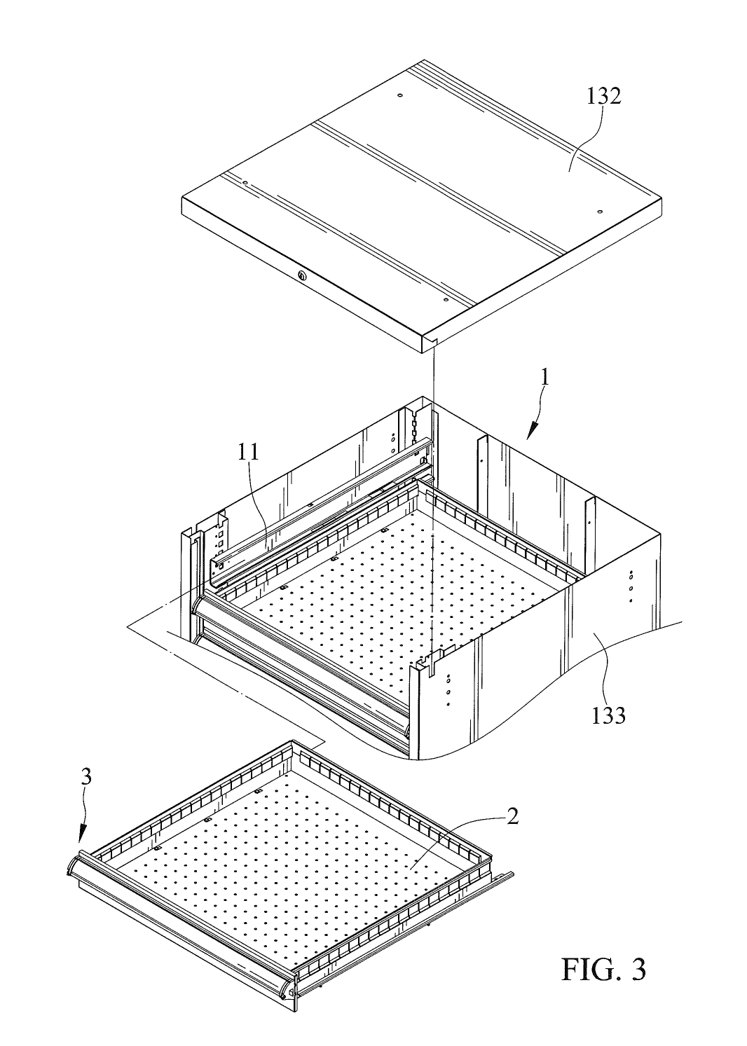

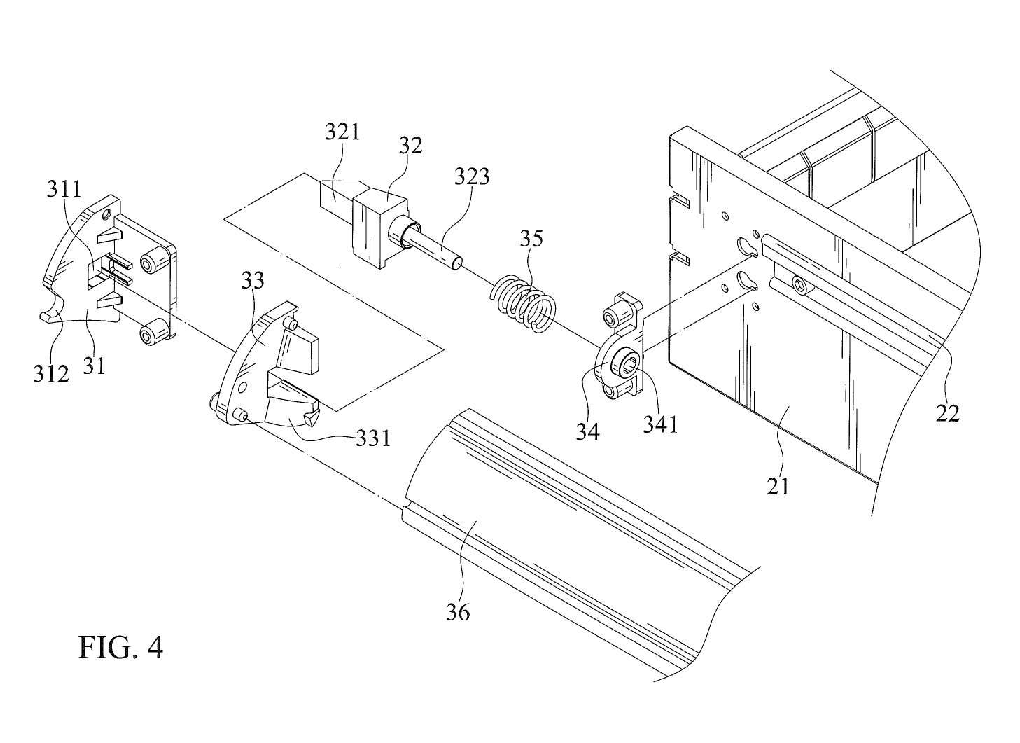

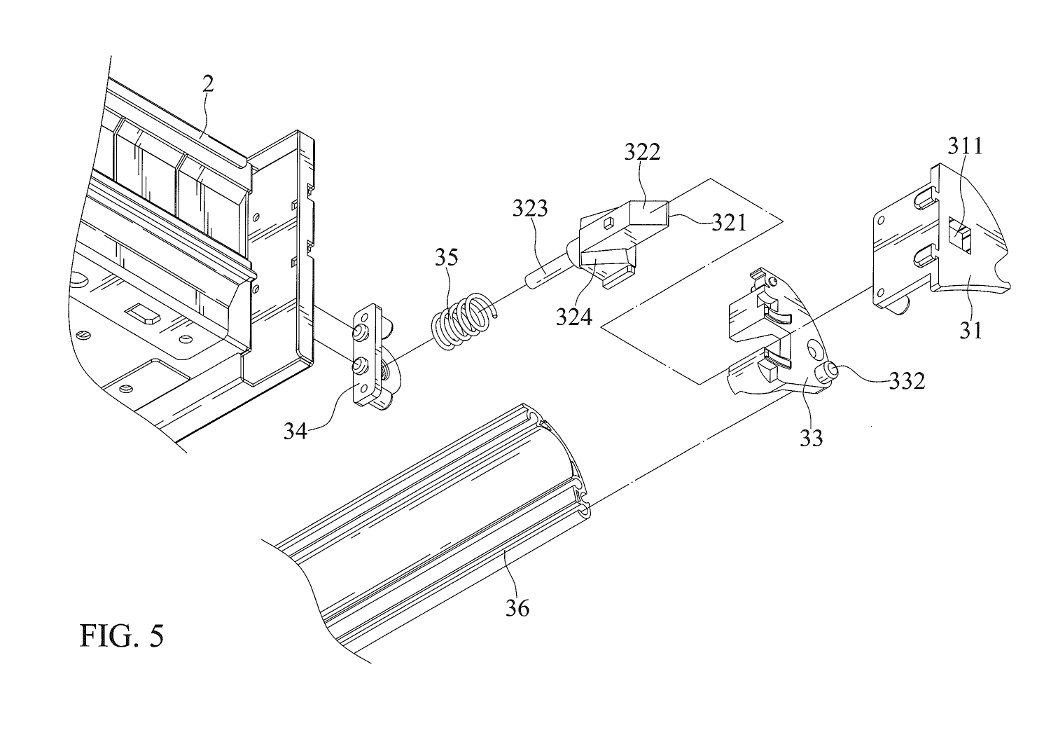

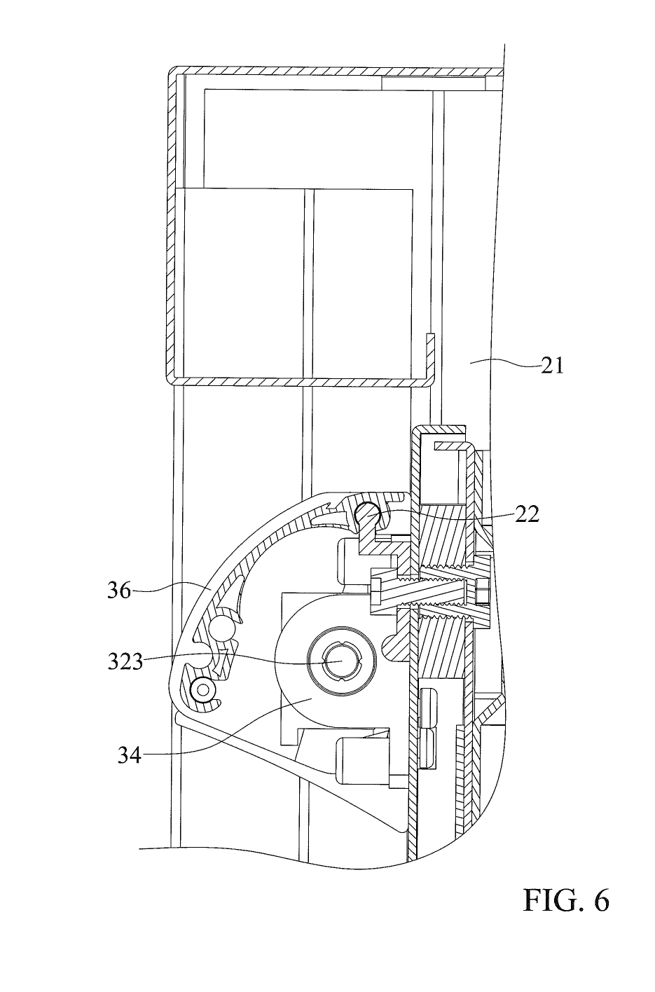

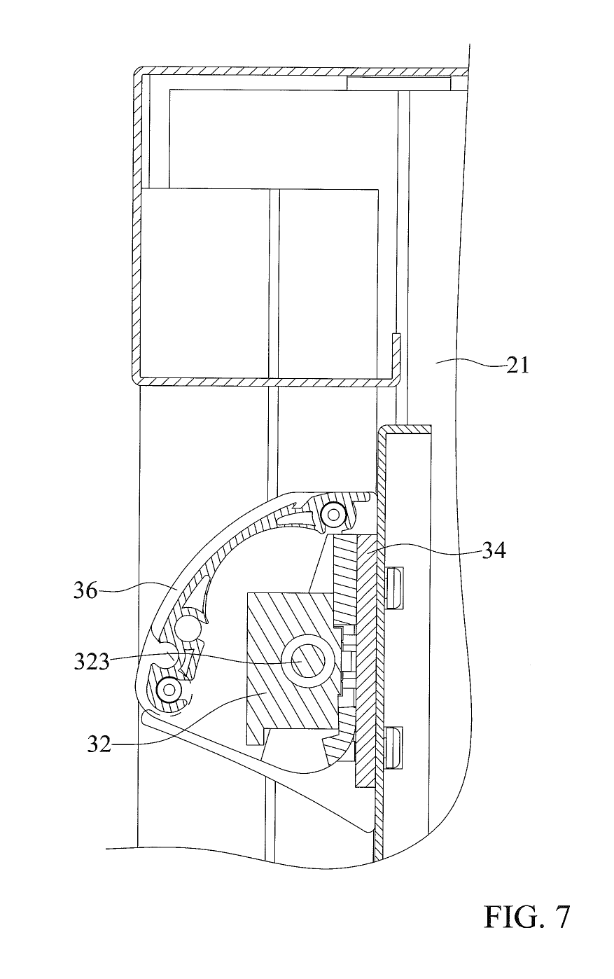

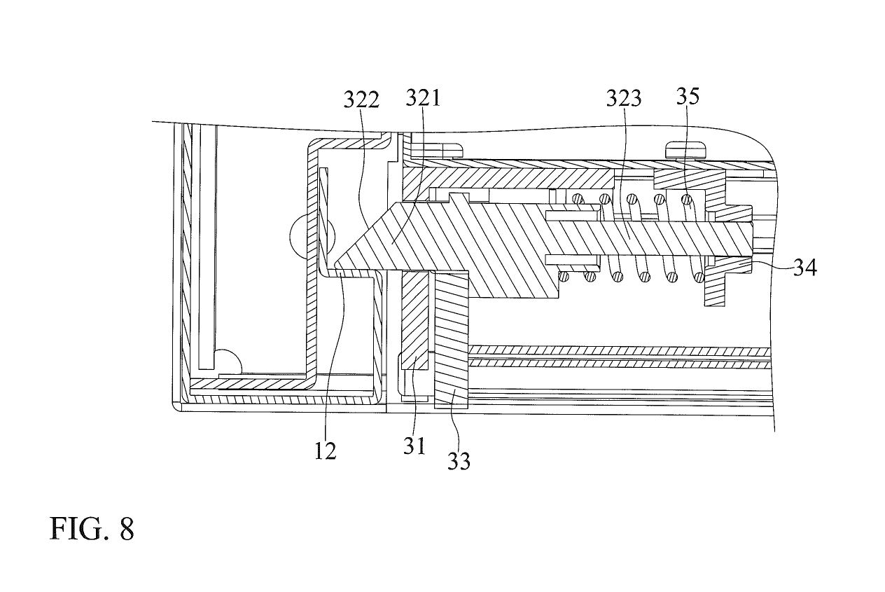

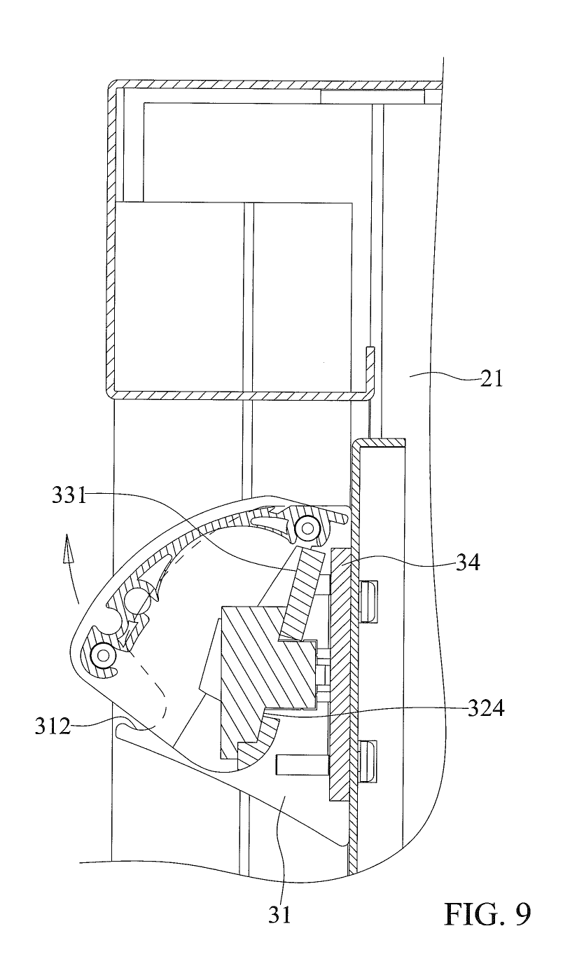

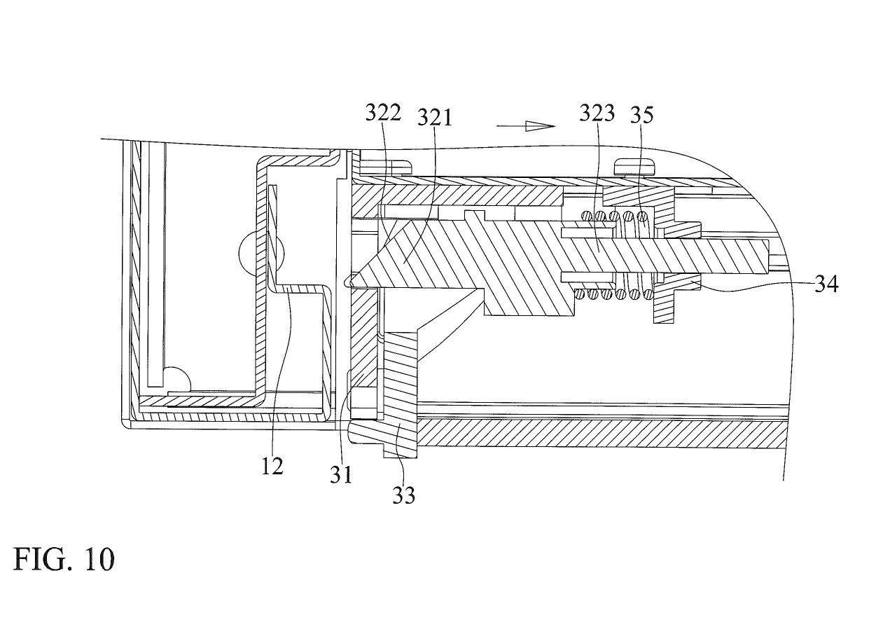

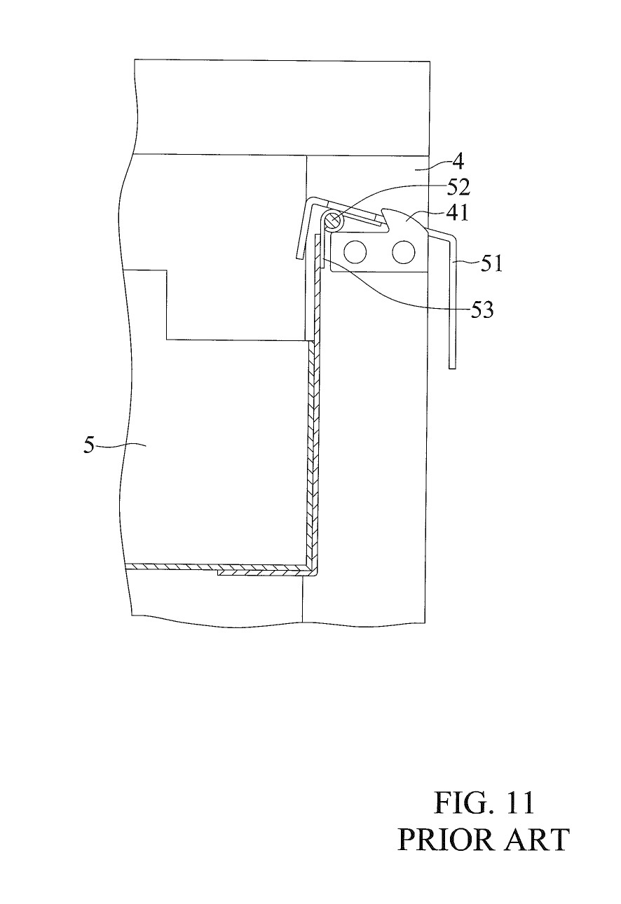

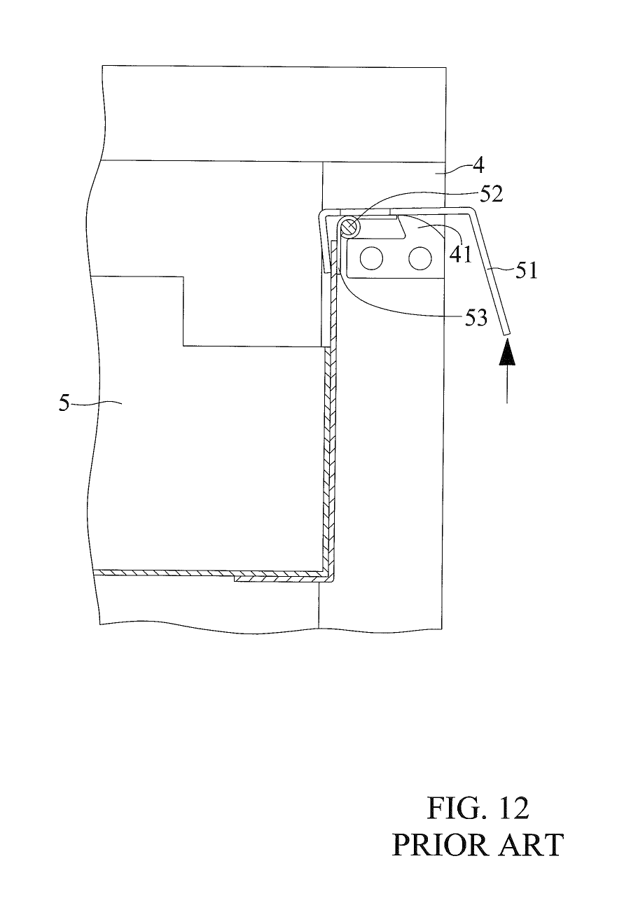

### DETAILED DESCRIPTION OF THE INVENTION

The present invention will become clearer in light of the following detailed description of an illustrative embodiment of this invention described in connection with the drawings. It is intended that the embodiments and drawings disclosed herein are to be considered illustrative rather than restrictive.

A tool cabinet 1 in accordance with the present invention includes a cabinet body, at least one drawer 2 received by the cabinet body, and at least one opening and closing device 3 engaged with the cabinet body and the at least one drawer 2, and a plurality of casters 4 mounted to the cabinet body.

The cabinet body has a bottom side 131, a top side 132, and a lateral side 133. The bottom and top sides 131 and 132 are disposed oppositely in a height direction of the cabinet body. The plurality of casters 4 is mounted to the bottom side 131 of the cabinet body. The plurality of casters 4 enable the tool cabinet 1 to be easily moved. Each of the plurality of casters 4 is a swivel caster, thereby making it possible to move the tool cabinet 1 in any direction without changing its orientation. The lateral side 133 extends in the height direction of the cabinet body from the bottom side 131 to the top side 132. The bottom 131, top 132, and the lateral sides 133 cooperate to define a chamber with an opening. The lateral side 133 is defined by three panels, with first and second panels disposed oppositely and the third panel extending between the first and second panels. At least one pair of slide modules 11 is disposed oppositely on the lateral side 133.

The at least one drawer 2 is slidably engaged with and retained by the at least one pair of slide modules 11 between an open position partially extending outside chamber through the opening and a closed position received in the chamber. The at least one drawer 2 is axially displaced between the open and closed positions.

The at least one opening and closing device 3 is configured to selectively prevent the at least one drawer 2 from being opened. The at least one drawer 2 is moved from the closed position to the open position in a first direction upon being opened. The opening and closing device 3 includes a first and second holder 31 and 34, a displacing member 32, a flipping member 33, a biasing member 35, and a control input 36.

The first and second holders 31 and 34 are attached to a front panel 21 of a drawer box of the at least one drawer 2. The first and second holders 31 and 34 are disposed oppositely. The first holder 31 has a first extension for attaching to the at least one drawer 2 and a second extension transverse to the first extension. The second extension of the first holder 31 has a peripheral edge defining a concave contour, and the limit portion 312 is defined by the concave contour. The first holder 31 is disposed corresponding to a recessed structure 12 defined by the lateral side 133 of the cabinet body.

The displacing member 32 is restrained by the first and second holders 31 and 34 and is movable relative thereto. The displacing member 32 is adapted to be moved to a position in which a control end 321 defined at an end thereof is disposed outside the first holder 31 and inserted into the recessed structure 12. The displacing member 32 is biased by the biasing member 35 which is restrained by the displacing member 32 and the second holder 34. The control end 321 is defined at a first end of the displacing member 32 and is adapted to insert through a through hole 311 defined by the second extension of the first holder 31. The displacing member 32 includes a guiding end 323 defined at a second end thereof and inserted into a hole 341 defined by the second holder 34. The displacing member 32 includes a first slant surface 324. The displacing member 32 includes the end thereof forming two opposite lateral sides and the first slant surface 324 has a first area disposed adjacent to one of the two lateral sides and a second area disposed adjacent to the other lateral side. The displacing member 32 includes the end thereof forming a slope surface 322 and the slope surface is extended between the two opposite lateral sides. The control end 321 of the displacing member 32 is delimited by the slope surface and the two opposite lateral sides. The displacing member 32 is therefore restrained by the first and second holders 31 and 34. The biasing member 35 is a spring, which has a shape defining a plurality of coils.

The flipping member 33 is restrained by the first holder 31 and is pivotal relative thereto. A pivotal connection for the flipping member 33 is defined on the second extension of the first holder 31. The flipping member 33 is configured to be pivotal to a first position in which a lug 332 defined by the flipping member 33 is received by a limit portion 312 defined by the first holder 31 and to a second position in which the lug 332 is not received by the limit portion 312. The flipped member 33 includes a second slant surface 331 in contact with the first slant surface 324. The flipping member 33 has a gap and the control end 321 of the displacing member 32 is inserted through the gap. The gap is disposed corresponding to the through hole 311. The gap is extended in the second slant surface 331 and the second slant surface 331 has a first area disposed on one side of the gap and a second area disposed on the other side of the gap. The first area of the first slant surface 324 is disposed corresponding to the first area of second slant surface 331 and the second area of the first slant surface 324 is disposed corresponding to the second area of the second slant surface 331 respectively.

Upon pivoting the flipping member 33 about a pivot axis, the displacing member 32 is adapted to be moved in a second direction which is transverse to the first direction. The second direction is substantially perpendicular to the first direction. The pivot axis extends in the second direction.

The control input 36 is integrated with the flipping member 33. Upon pivoting the control input 36 in the second direction, the flipping member 33 is adapted to be pivoted in the second direction. The control input 36 is connected to a joint 22 extending from the front panel 21 and being pivotal thereto. The joint 22 is positioned on the pivot axis.

The at least one drawer 2 in the closed position is prevented from being opened when the control end 321 is inserted into the recessed structure. The flipping member 33 is configured to be pivoted to the first position in which the control end 321 of the displacing member 32 is inserted into the recessed structure 12 of the cabinet body, and to the second position in which the control end 321 is not inserted into the recessed structure 12.

In view of the forgoing, the tool cabinet 1 includes at least one drawer 2 and at least one drawer opening and closing device 3 interacted with the at least one drawer 2 and configured to be movable to a first position in which the at least one drawer 2 can be pulled out, and to a second position in which the at least one drawer 2 is locked and prevented from being pulled out.

What is claimed is:

1. A tool cabinet comprising:
a cabinet body having a bottom side, a top side, and a lateral side, with the bottom and top sides disposed oppositely in a height direction of the cabinet body, with the lateral side extending in the height direction of the cabinet body from the bottom side to the top side, with the bottom, top, and the lateral sides cooperated to define a chamber with an opening;
at least one pair of slide modules disposed oppositely on the lateral side;
at least one drawer received by the chamber and slidably engaged with and retained by the at least one pair of slide modules between an open position partially extending outside chamber through the opening and a closed position received in the chamber; and
at least one opening and closing device engaged with the cabinet body and the at least one drawer and configured to selectively prevent the at least one drawer from being opened, wherein the at least one drawer is moved from the closed position to the open position in a first direction upon being opened, wherein the opening and closing device includes a first and second holder, a displacing member, a flipping member, a biasing member, and a control input, wherein the first and second holders are attached to a front panel of a drawer box of the at least one drawer, wherein the first holder is disposed corresponding to a recessed structure defined by the lateral side of the cabinet body, wherein the displacing member is restrained by the first and second holders and is movable relative thereto, wherein the displacing member is adapted to be moved to a position in which a control end defined at an end thereof is disposed outside the first holder and inserted into the recessed structure, wherein the displacing member is biased by the biasing member which is restrained by the displacing member and the second holder, wherein the flipping member is restrained by the first holder and is pivotal relative thereto, wherein the displacing member includes a first slant surface and the flipped member includes a second slant surface in contact with the first slant surface, wherein upon pivoting the flipping member about a pivot axis, the displacing member is adapted to be moved in a second direction which is transverse to the first direction, wherein the pivot axis extends in the second direction, wherein the control input is integrated with the flipping member, and wherein upon pivoting the control input in the second direction, the flipping member is adapted to be pivoted in the second direction;
wherein the at least one drawer in the closed position is prevented from being opened when the control end is inserted into the recessed structure.

2. The tool cabinet as claimed in claim 1, wherein the flipping member is configured to be pivotal to a first position in which a lug defined by the flipping member is received by a limit portion defined by the first holder and to a second position in which the lug is not received by the limit portion.

3. The tool cabinet as claimed in claim 2, wherein the flipping member is configured to be pivoted to the first position in which the control end of the displacing member is inserted into the recessed structure of the cabinet body, and to the second position in which the control end is not inserted into the recessed structure.

4. The tool cabinet as claimed in claim 2, wherein the first holder has a first extension for attaching to the at least one drawer and a second extension transverse to the first extension, wherein a pivotal connection for the flipping member is defined on the second extension, and wherein the second extension of the first holder has a peripheral edge defining a concave contour, and the limit portion is defined by the concave contour.

5. The tool cabinet as claimed in claim 1, wherein the control end is defined at a first end of the displacing member and is adapted to insert through a through hole defined by the second extension of the first holder, and wherein the displacing member includes a guiding end defined at a second end thereof and inserted into a hole defined by the second holder.

6. The tool cabinet as claimed in claim 5, wherein the flipping member has a gap and the control end of the displacing member is inserted through the gap, and wherein the gap is disposed corresponding to the through hole.

7. The tool cabinet as claimed in claim 6, wherein the displacing member includes the end thereof forming two opposite lateral sides and the first slant surface has a first area disposed adjacent to one of the two lateral sides and a second area disposed adjacent to the other lateral side, wherein the gap extends in the second slant surface and the second slant surface has a first area disposed on one side of the gap and a second area disposed on the other side of the gap, and wherein the first area of the first slant surface is disposed corresponding to the first area of second slant surface and the second area of the first slant surface is disposed corresponding to the second area of the second slant surface respectively.

8. The tool cabinet as claimed in claim 7, wherein the displacing member includes the end thereof forming a slope surface and the slope surface extends between the two opposite lateral sides, and wherein the control end of the displacing member is delimited by the slope surface and the two opposite lateral sides.

9. The tool cabinet as claimed in claim 1 further comprising a plurality of casters mounted to the bottom side of the cabinet body.

10. The tool cabinet as claimed in claim 1, wherein the control input is connected to a joint extending from the front panel and being pivotal thereto, and wherein the joint is positioned on the pivot axis.

11. The tool cabinet as claimed in claim 3, wherein the first holder has a first extension for attaching to the at least one drawer and a second extension transverse to the first extension, wherein a pivotal connection for the flipping member is defined on the second extension, and wherein the second extension of the first holder has a peripheral edge defining a concave contour, and the limit portion is defined by the concave contour.

12. The tool cabinet as claimed in claim 11, wherein the control end is defined at a first end of the displacing member and is adapted to insert through a through hole defined by the second extension of the first holder, and wherein the displacing member includes a guiding end defined at a second end thereof and inserted into a hole defined by the second holder.

13. The tool cabinet as claimed in claim 12, wherein the flipping member has a gap and the control end of the displacing member is inserted through the gap, and wherein the gap is disposed corresponding to the through hole.

14. The tool cabinet as claimed in claim 13, wherein the displacing member includes the end thereof forming two opposite lateral sides and the first slant surface has a first area disposed adjacent to one of the two lateral sides and a second area disposed adjacent to the other lateral side, wherein the gap extends in the second slant surface and the second slant surface has a first area disposed on one side of the gap and a second area disposed on the other side of the gap, and wherein the first area of the first slant surface is disposed corresponding to the first area of second slant surface and the second area of the first slant surface is disposed corresponding to the second area of the second slant surface respectively.

15. The tool cabinet as claimed in claim 14, wherein the displacing member includes the end thereof forming a slope surface and the slope surface extends between the two opposite lateral sides, and wherein the control end of the displacing member is delimited by the slope surface and the two opposite lateral sides.

16. The tool cabinet as claimed in claim 3 further comprising a plurality of casters mounted to the bottom side of the cabinet body.

17. The tool cabinet as claimed in claim 3, wherein the control input is connected to a joint extending from the front panel and being pivotal thereto, and wherein the joint is positioned on the pivot axis.
